(19) United States
(12) Patent Application Publication
(10) Pub. No.: US 2010/0251296 A1
(43) Pub. Date: Sep. 30, 2010

(54) CHANNEL SWITCHING METHOD AND SYSTEM FOR IPTV SERVICE

(75) Inventors: Jun Hyung KIM, Suwon-si (KR); Kyung Tae Kim, Suwon-si (KR); Sung Oh Hwang, Yongin-si (KR); Hee Yong Youn, Seongnam-si (KR); Sang Won Rhee, Seoul (KR)

Correspondence Address: THE FARRELL LAW FIRM, LLP, 290 Broadhollow Road, Suite 210E, Melville, NY, 11747, US

(73) Assignees: Samsung Electronics Co., Ltd., Suwon-si (KR); Sungkyunkwan University Foundation For Corporate Collaboration, Suwon-si (KR)

(21) Appl. No.: 12/731,627

(22) Filed: Mar. 25, 2010

(30) Foreign Application Priority Data
Mar. 25, 2009 (KR) 10-2009-0025424

(51) Int. Cl. H04N 5/445

(52) U.S. Cl. 725/38

(57) ABSTRACT

A channel switching method and system for IPTV for reducing channel switching delay and improving bandwidth utilization efficiency is provided. The channel switching method includes pre-joining candidate channels while playing broadcast data on a main channel, the candidate channels being stored in a candidate channel table; releasing the pre-joined candidate channels, when a channel holding time of the main channel is greater than a predetermined channel holding time level; and re-joining the released candidate channels before a completion of playing the broadcast data on the main channel.

### PRIORITY

This application claims priority to an application filed with the Korean Intellectual Property Office on Mar. 25, 2009 and assigned Serial No. 10-2009-0025424, the contents of which are incorporated herein by reference.

### BACKGROUND OF THE INVENTION

1. Field of the Invention

The present invention relates generally to Internet Protocol TeleVision (IPTV) and, in particular, to a channel switching method and system for IPTV that reduces channel switching delay and improves bandwidth utilization efficiency.

2. Description of the Related Art

IPTV is a digital broadcasting system that supports interactive digital television over a broadband network infrastructure. Unlike conventional terrestrial broadcast and cable broadcast services, the IPTV service channels are transmitted to a Set-Top Box (STB) or a Home Gateway connected to a user terminal over a limited bandwidth.

Due to bandwidth limitations, the number of service channels that can be transmitted simultaneously is limited. Accordingly, one of the challenges faced by IPTV is a channel switching delay, also known as a channel zapping time, which a user experiences when switching to a new channel. The channel zapping time is one of the factors that determines a Quality of Experience (QoE) of the end users in an IPTV system.

The channel zapping time consists of the Internet Group Management Protocol (IGMP) processing delay required for changing a multicast group, which includes the current STB using the IGMP messages and report messages, as well as the decoding delay required for the STB to decode the received broadcast data. Several methods for reducing the IGMP processing delay, and thus, the channel zapping time, have been proposed.

One such method for reducing the IGMP delay includes registering available candidate channels with a router with a modified IGMP message so as to reduce the IGMP processing delay. More specifically, this method allows the user terminal to receive and play broadcast data of the registered candidate channels in the form of auxiliary display windows along with the main display window of the current channel. Since the candidate channels played in the auxiliary display windows are registered with the router, it is possible to reduce the channel switching delay. The candidate channels can be channels adjacent to the current channel or favorite channels preregistered by the user. The candidate channels can be processed in background without displaying the auxiliary display windows.

Another method for reducing the IGMP delay includes pre-joining expected next channels in consideration of channel surfing patterns and user preferences for reducing the channel zapping time. This method improves a prediction accuracy of pre-join channels so as to reduce the channel zapping time.

Such conventional methods use either the adjacent channels of the main channel or the user favorite channels as the candidate channels for a next expected channel. When adjacent channels are set as the candidate channels, the user favorite channels-based candidacy is ruled out such that, when the user requests switching to a favorite channel, bandwidth is wasted and the channel zapping time reduction effect is negated. The same problem occurs when the user favorite channels are set as the candidate channels and the user requests switching to an adjacent channel. Also, in case of the pre-joining method, since the favorite channels of user who infrequently use the IPTV service are likely to be ignored, it is required to take into account the personalized channel preferences.

The conventional methods for reducing the channel zapping time focus on methods that include pre-joining the candidate channels in advance. However, these methods have drawback in that the broadcast data of the candidate channels are transmitted to the router in advance, resulting processing overhead of the router and bandwidth overhead of the network. Furthermore, joining the candidate channels for long without channel switching increases the waste of resource, resulting in degradation of bandwidth efficiency.

### SUMMARY OF THE INVENTION

In order to overcome the problem of the prior art, the present invention provides a fast channel switching method and system for IPTV service that is capable of minimizing channel zapping time.

In accordance with an embodiment of the present invention, a channel switching method for a system playing broadcast data delivered on channels includes pre-joining candidate channels while playing broadcast data on a main channel, the candidate channels being stored in a candidate channel table; releasing the pre-joined candidate channels when a channel holding time of the main channel is greater than a predetermined channel holding time level; and re-joining the released candidate channels before a completion of playing the broadcast data on the main channel.

In accordance with another embodiment of the present invention, a channel switching method of a home gateway delivering broadcast data from a content provision server to a user terminal includes transmitting, to the user terminal, broadcast data of a main channel selected by the user terminal; pre-joining candidate channels selected in association with the main channel; determining whether a main channel holding time of the user terminal is greater than a predetermined channel holding time level; releasing the pre-joined candidate channels when the main channel holding time of the user terminal is greater than the channel holding time level; and re-joining the released candidate channels before a completion of playing the broadcast data on the main channel.

In accordance with still another embodiment of the present invention, a channel switching system includes a home gateway for transmitting broadcast data on a main channel, pre-joining candidate channels stored in a candidate channel table in association with the main channel, releasing the pre-joined candidate channels when a channel holding time of the main channel is greater than a predetermined channel holding time level, checking a play completion time of the broadcast data on the main channel, and re-joining the released candidate channels before the play completion time; and at least one user terminal for playing the broadcast data transmitted by the home gateway and transmitting, when a main channel switching event is detected, a channel switching request to the home gateway.

### BRIEF DESCRIPTION OF THE DRAWINGS

The above and other objects, features and advantages of the present invention will be more apparent from the following detailed description in conjunction with the accompanying drawings, in which:

FIG. 1 is a block diagram illustrating a channel switching system for an IPTV service according to an embodiment of the present invention;

FIG. 2 is a diagram illustrating formats of tables related to channel information according to an embodiment of the present invention;

FIG. 3 is a sequence diagram illustrating operations of network entities for channel switching according to an embodiment of the present invention;

FIG. 4 is a flowchart illustrating a pre-join procedure of a Home Gateway (HG) in a channel switching method according to an embodiment of the present invention;

FIG. 5 is a diagram illustrating formats of a channel information message transmitted by an HG for use in a channel switching method according to an embodiment of the present invention;

FIG. 6 is a diagram illustrating a format of a response message transmitted by a content provision server for use in a channel switching method according to an embodiment of the present invention;

FIG. 7 is a diagram illustrating a principle for calculating play time on a channel in a channel switching method according to an embodiment of the present invention;

FIG. 8 is a flowchart illustrating a candidate channel table update procedure in a channel switching method according to an embodiment of the present invention;

FIG. 9 is a graph illustrating a principle of extracting a VT_{MAX} for the channel switching method according to an embodiment of the present invention;

FIG. 10 is a diagram illustrating a principle of determining a PTT level in the channel switching method according to an embodiment of the present invention; and

FIG. 11 is a diagram illustrating PPT levels for use in the channel switching method according to an embodiment of the present invention.

### DETAILED DESCRIPTION OF EMBODIMENTS

In the following description, the term ‘join’ denotes the establishing a connection with a channel. The term ‘broadcast data’ denotes the data transmitted from a content provider server to a user terminal over a network and output by means of a user terminal. The broadcast data includes voice, video, text data, and the like. The term ‘main channel’ denotes the channel currently played on the user terminal. The term ‘candidate channels’ denotes channels expected to be selected according to a next channel switch request of the user. The candidate channels can be classified into two categories: adjacent channel and user favorite channel. The term ‘adjacent channel’ denotes a channel neighboring the main channel. The term ‘user favorite channel’ denotes a channel that is frequently selected by the user.

Embodiments of the present invention are described with reference to the accompanying drawings. The same reference numbers are used throughout the drawings to refer to the same or similar parts. The described features and advantages of the invention may be combined in any suitable manner in one or more embodiments and one skilled in the art will recognize that the invention may be practiced without one or more of the specific features or advantages of a particular embodiment. Detailed descriptions of well-known functions and structures incorporated herein may be omitted to avoid obscuring the subject matter of the present invention.

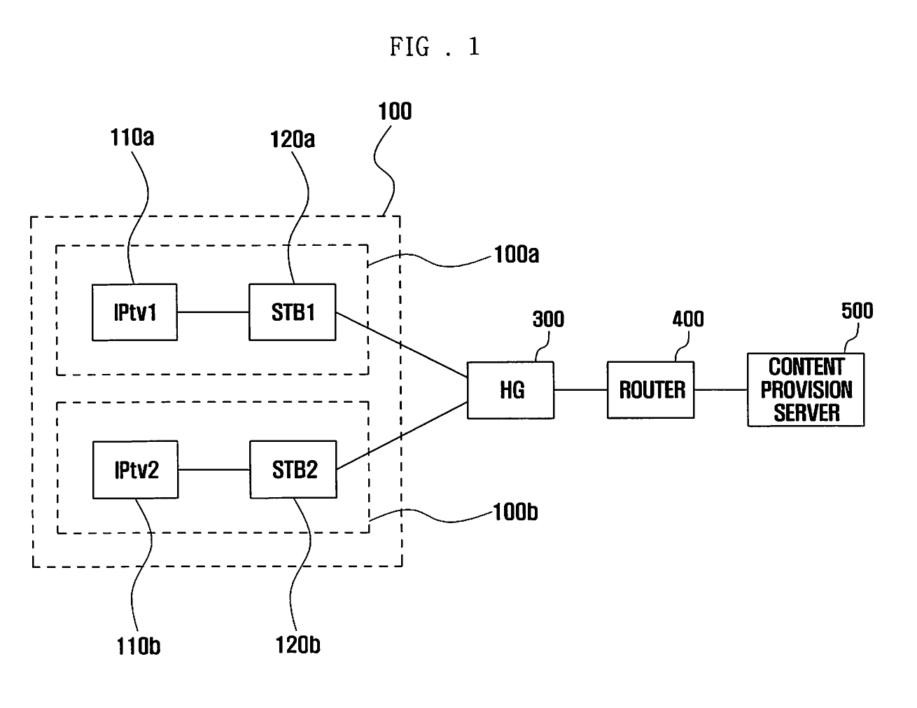

FIG. 1 is a block diagram illustrating a channel switching system for an IPTV service according to an embodiment of the present invention.

Referring to FIG. 1, the channel switching system includes a home network 100, a Home Gateway (HG) 300, a router 400, and a content provision server 500.

The home network 100 includes STB1 120a and STB2 120b, which are capable of receiving the digital broadcast data transmitted by the content provision server 400 and converting the digital broadcast data to analog broadcast data. The home network 100 also includes user terminals 110a and 110b, which are capable of playing the analog broadcast data to users. The home network 100 can include at least one user terminal that is connected to a corresponding STB.

The HG 300 connects STB1 120a and STB2 120b to the router 400 and relays the data between the router 400 and each of STB1 120a and STB2 120b, respectively. The HG 300 establishes a channel with the content provision server 500 and delivers the broadcast data received through the channel to the user terminals 100a and 100b. The HG 300 can pre-join the candidate channels selected from among all channels except the current playback channel (main channel) of user terminals 110a and 110b. The candidate channels can be the adjacent channels or the user favorite channels.

The adjacent channels are channels neighboring the main channels. For instance, if the content provision server 500 provides 9 service channels assigned respective channel numbers 6, 7, 9, 10, 11, 13, and 20, and the main channel is 9, then channels 7 and 10 are the channels adjacent to channel 9.

The favorite channels are the channels through which the user terminals 110a and 110b are most frequently connected to via the HG 300 or the channels most frequently selected by users. The favorite channels determined based on the number of connections to each respective channel. For instance, if the content provision server 500 provides 9 service channels assigned respective channel numbers 6, 7, 9, 10, 11, 13, and 20, and these channel numbers are selected 2, 7, 13, 40, 35, 5, and 27 respectively; the channel 10 selected 40 times and the channel 11 selected 35 times become the first and second favorite channels.

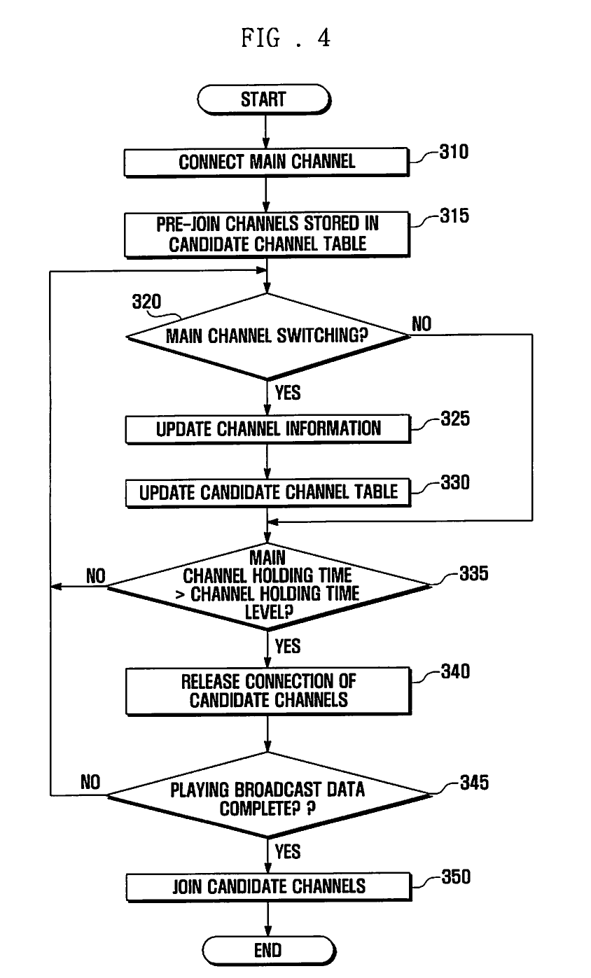

The HG 300 pre-joins the candidate channels of the user terminals 110a and 110b playing the broadcast data of the main channel. Pre-joining of the candidate channels described with reference to FIGS. 4 to 11.

The router 400 establishes a path of the broadcast data from the content provision server 500 to the HG 300. The HG 300 registers the candidate channels with the router 400 according to the IGMP protocol, and the router 400 forwards the broadcast data provided by the content provision server 400 to the HG 300 via multicast routing.

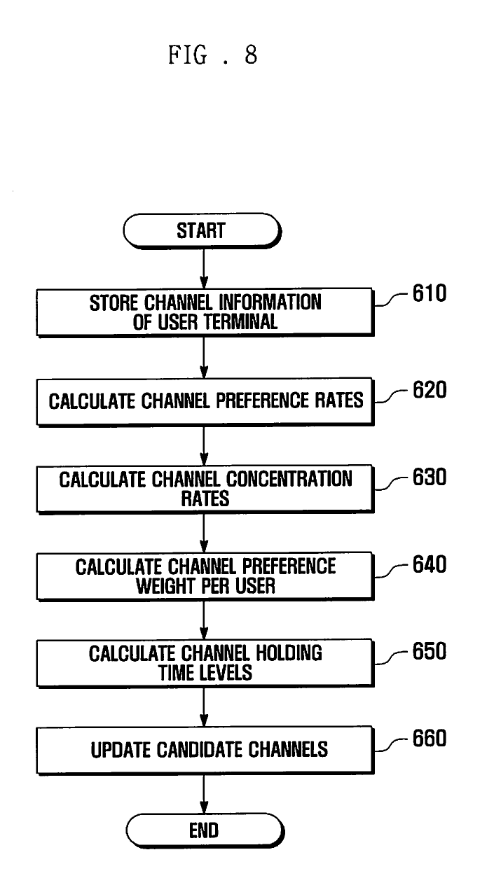

The content provision server 500 provides the user terminals 110a and 110b with various data. The various data, which may include video, picture, text, and voice data, is referred to as broadcast data with regard to embodiments of the present invention. The content provision server 500 stores, in a database, the channel information message transmitted by the HG 300. The content provision server 500 computes channel preference weight, channel concentration, and channel holding time level per user terminal and sends the channel preference weight, channel concentration, and channel holding time level to the HG 300. The HG 300 can update the candidate channels based on the channel preference weight, channel concentration, and channel holding time level. Calculation of the channel preference weight, the channel concentration, and the channel holding time level is described herein with reference to FIGS. 8 to 11.

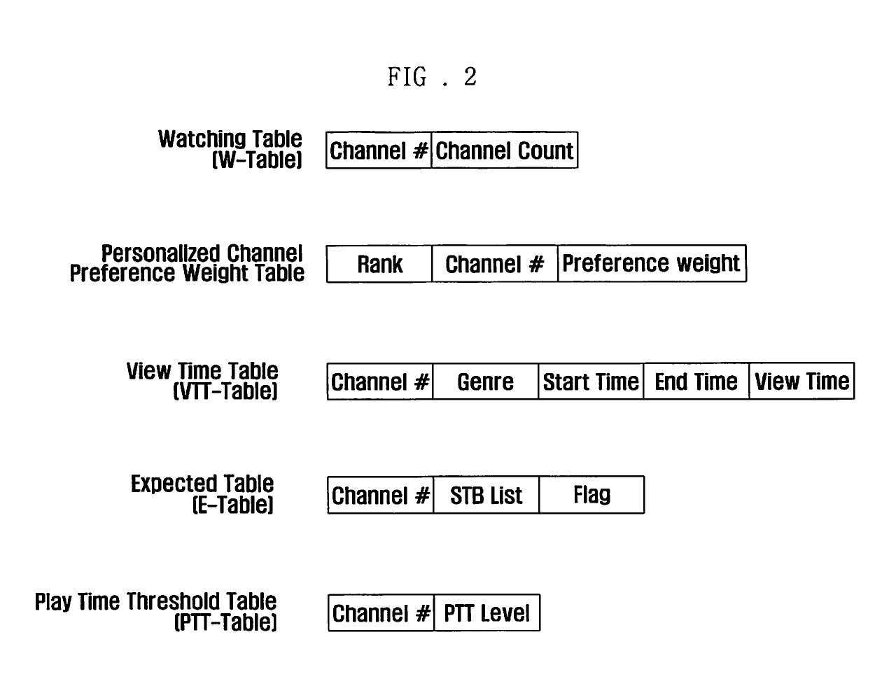

The HG 300 and the content provision server 500 store information about the channels carrying the broadcast data in the form of tables. The tables related to channel information is described as follows with reference to FIG. 2.

FIG. 2 is a diagram illustrating the formats of a tables related to channel information according to an embodiment of the present invention.

Referring to FIG. 2, the HG 300 and the content provision server 500 share a plurality of channel-related tables including a Watching Table (W-table), a Personalized Channel Preference Weight Table, a View Time Table (VTT-Table), an Expected Table (E-Table), and a Play Time Threshold Table (PTT-Table). These tables can be defined as shown in table 1.

TABLE 1

| Table Name | Fields | Definition |
|---|---|---|
| Watching Table | Channel# | Main channel of which |
| (W-Table) | | broadcast data is played by |
| | | terminal. |
| | Channel | Number of channels connected |
| | Count | to the terminal. |
| Personalized Channel | Rank | Rank of channel preference |
| Preference Weight Table | Channel# | Channel number |
| | Preference | Preference weight value |
| | weight | |
| View Time Table | Channel# | Main channel of which |
| (VTT-Table) | | broadcast data is played by |
| | | terminal. |
| | Genre | Genre |
| | Start Time | Start time of playback |
| | End Time | End time of playback |
| | View Time | Total play time |
| Expected Table | Channel# | Numbers of adjacent channels |
| (E-Table) | STB List | User terminal list |
| | Flag | Indication of Join connection |
| Play Time Threshold | Channel# | Channel number |
| Table (PTT-Table) | PTT Level | Per-channel play time level |

The Personalized Channel Preference Weight Table, Expected Table (E-Table), and Play Time Threshold Table (PTT-Table) store information about the candidate channels that the HG 300 pre-joins. The candidate channel tables are shared by the HG 300 and the content provision server 500. Hereinafter, the Personalized Channel Preference Weight Table is referred to as a “favorite channel table”, the Expected Table (E-table) is referred to as an “adjacent channel table”, and the Play Time Threshold Table (PTT-Table) is referred to as a “channel holding time level table”.

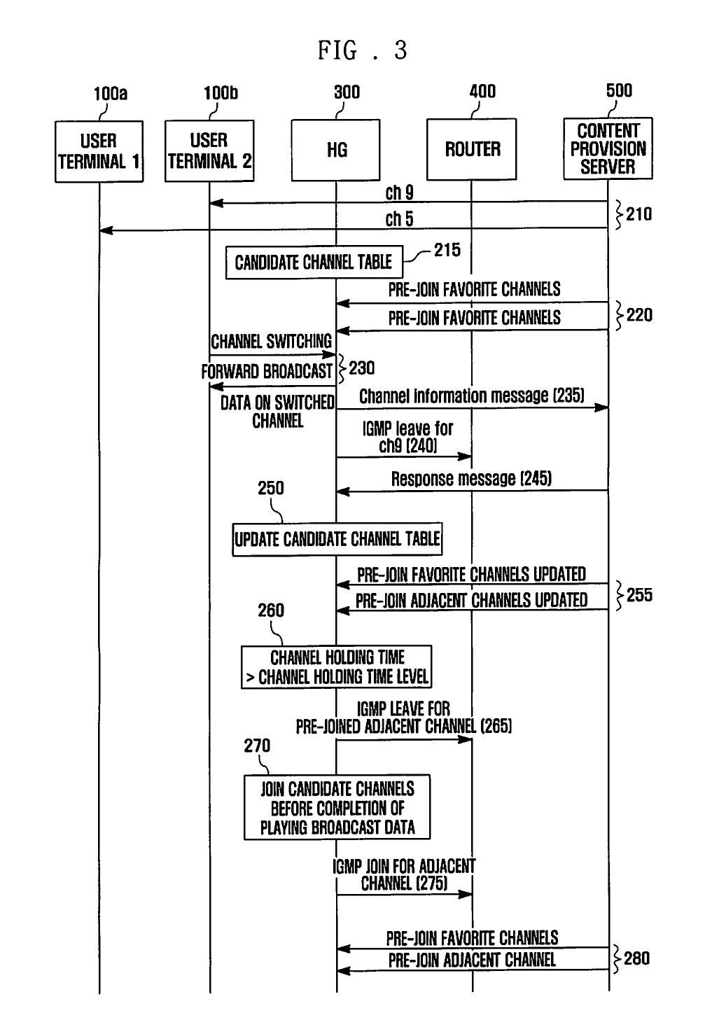

Signaling among entities for a channel switching procedure is described as follows with reference to FIG. 3.

FIG. 3 is a sequence diagram illustrating operations of the network entities for channel switching according to an embodiment of the present invention.

Referring to FIG. 3, the user terminals 100a and 100b receive and play broadcast data provided by the content provision server 400 on channels 5 and 9, respectively, in step 210. The HG 300 checks the previously stored candidate channel tables, in step 215. The candidate channel tables include the adjacent channel table, favorite channel table, and channel holding time level table. The candidate channels stored in the favorite channel table are sorted in order of selection frequency rank. The candidate channel tables can be formed as Table 2.

TABLE 2

| | | | | | | Channel holding time | |
|---|---|---|---|---|---|---|---|
| Adjacent channel table | | | Favorite channel table | | | level table | |
| CH | STB list | Flag | Rank | CH | Preference | CH | Level (PTT) |
| 4 | STB1 | O | 1 | 13 | 0.8872 | 1 | L4 |
| 6 | STB1 | O | 2 | 20 | 0.8643 | 2 | L2 |
| 8 | STB2 | O | 3 | 16 | 0.7985 | . . . | . . . |
| 10 | STB2 | O | 4 | 2 | 0.7128 | 9 | L3 |
| | | | 5 | 25 | 0.6739 | 13 | L2 |
| | | | 6 | 9 | 0.6723 | . . . | . . . |

Each STB can represent a corresponding user terminal. For example, the STB1 is connected to the first user terminal 100a, and the STB2 is connected to the second User terminal 100b. The first user terminal 100a plays broadcast data of CH5 selected from among available channels CH1 to CH10. In this case, the channels CH4 and CH6 are the adjacent channels of the current channel CH5. The second user terminal 100b plays the broadcast data of CH9. Accordingly, CH9 is the current channel (main channel) of the second user terminal 100b, and CH8 and CH10 are the adjacent channels of the current channel CH9. A flag indicates whether the HG 300 has pre-joined a corresponding channel. A flag set to ‘O’ indicates that the HG 300 has pre-joined the channel. Otherwise, a flag set to ‘X’ indicates that the HG 300 has not pre-joined the channel.

The candidate channel table also stores information about the channel holding time level (Play Time Threshold or PTT) for each channel. The PTT is a level for the HG 300 to release the pre-joined candidate channel.

The HG 300 can pre-join at least one favorite channel or adjacent channel assigned as candidate channel by the content provision server 500, in step 220. For example, the HG 300 can pre-join the adjacent channels CH4 and CH6 or the favorite channels CH13, CH20, and CH16 for the STB1 120a. The HG 300 receives a channel switching request from the second user terminal 100b and transmits the broadcast data of the switched new channel in response to the channel switching request, in step 230. When the main channel of the second user terminal 100b is switched from CH 9 to CH13, for example, the HG 300 can transmit the broadcast data of CH13 to the second user terminal 100b immediately, since CH13 has been pre-joined as one of the favorite channels. The HG 300 sends a channel information message containing the information on the new main channel of the second User terminal 100b to the content provision server 500, in step 235.

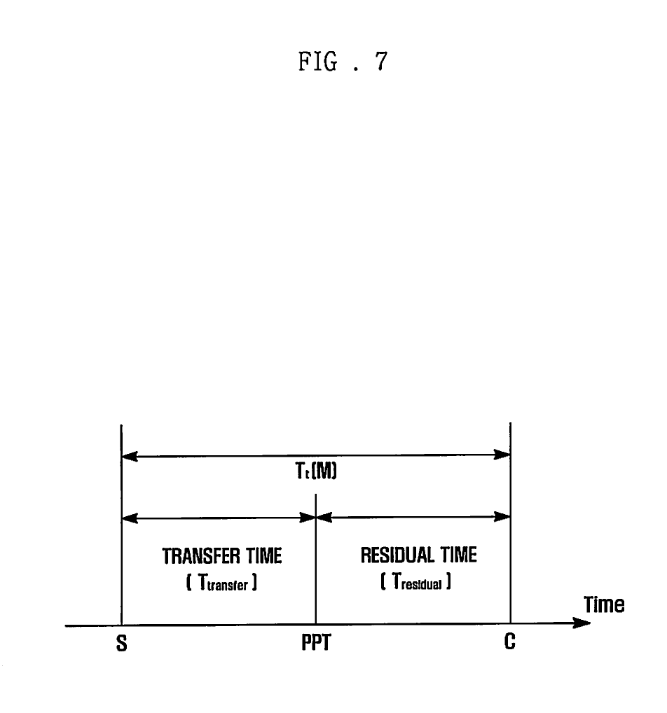

The HG 300 sends an IGMP leave message for CH9 to the router 400, in step 240. Although not depicted in drawing, the content provision server 500 can store the channel information of the second user terminal 100b, carried by the channel information message, in the database of the content provision server 500. The content provision server 500 calculates the channel preference and channel concentration values using the channel information. The content provision server 500 also calculates the channel preference weight using the channel preference and channel concentration values. The content provision server 500 updates the candidate channel table using the channel preference weights and per-channel holding time level. Calculation of the channel preference weight and per-channel holding time level is described herein with reference to FIG. 7.

The content provision server 500 sends the HG 300 a response message containing the channel preference weight and per-channel holding time level in response to the channel information message, in step 245. Upon receiving the response message, the HG 300 updates its candidate channel table using the channel preference weight and per-channel holding time level carried by the response message, in step 250. The candidate channel table of the HG 300 can be updated as shown in Table 3.

TABLE 3

| | | | | | | Channel holding time | |
|---|---|---|---|---|---|---|---|
| Adjacent channel table | | | Favorite channel table | | | level table | |
| CH | STB list | Flag | Rank | CH | Preference | CH | Level (PTT) |
| 4 | STB1 | O | 1 | 13 | 0.8872 | 1 | L4 |
| 6 | STB1 | O | 2 | 20 | 0.8643 | 2 | L2 |
| 12 | STB2 | O | 3 | 16 | 0.7985 | . . . | . . . |
| 14 | STB2 | O | 4 | 2 | 0.7128 | 9 | L1 |
| | | | 5 | 9 | 0.6754 | 13 | L1 |
| | | | 6 | 25 | 0.6737 | . . . | . . . |

Referring to Tables 2 and 3, in step 250, the preference rate of channel CH 9 for the second user terminal 100b changes from 0.6723 to 0.6754, the rank of channel CH9 changes from 6 to 5, the per-channel holding time level of channel CH 9 changes from L3 to L2, and the per-channel holding time level of channel CH13 changes from L2 to L1. As a consequence, the adjacent channels for the second user terminal 100b change from CH8 and CH10 to CH12 and CH14.

After updating the candidate channel table, the HG 300 pre-joins at least one favorite or adjacent channel by referencing the updated candidate channel table, in step 255. The HG 300 can pre-register channels CH12 and CH14 as the adjacent channels and the channels CH20, CH16, and CH2 as the favorite channels. Since CH13 having the first rank score is the main channel, the channels CH20, CH16, and CH2 ranked in descending order become the preference channels. Since the channels CH20 and CH16 have been pre-joined already, the HG 300 only needs to additionally pre-join the channel CH2. Although not depicted in drawing, when pre-joining the candidate channels, the HG 300 sends, to the router 400, an IGMP report about the channels CH12, CH14, and CH2. Upon receiving the IGMP report, the router 400 registers the multicast addresses for the respective channels CH12, CH14, and CH2 and transmits the broadcast data corresponding to the channels CH12, CH14, and CH2 to the HG 300.

The HG 300 determines whether the channel holding time of the second User terminal 100b on the corresponding channel is greater than the channel holding time threshold level, in step 260. If the channel holding time is greater than the channel holding time threshold level, the HG 300 sends the router 400 an IGMP Leave message for releasing the pre-joined adjacent channels, in step 265.

The HG 300 joins at least one candidate channel before the playback of the broadcast data on the current channel is completed, in step 270. The HG 300 joins the candidate channel because the channel switching probability increases after the completion of the broadcast data playback on the main channel. In order to make preparation for the channel switching to a new channel, the HG 300 pre-joins the candidate channels. The HG 300 can predict the playback completion of the broadcast data on the main channel by checking a daily broadcast program list and broadcast information provided by the content provision server 500 and the broadcast data information received when the terminal has joined the main channel. The HG 300 joins the candidate channels before β from the time point at which the playback of the broadcast data of the main channel is completed. β is a value set by the service provider managing the content provision server 400. β can also represent a channel switching time calculated statistically based on the broadcast data information of the user terminals 100a and 100b.

In order to join the candidate channels, the HG 300 sends the router 400 an IGMP join message for the released adjacent channels, in step 275. Next, the HG 300 pre-joins the adjacent channels and favorite channels carrying the broadcast data provided by the content provision server 500, in step 280.

Although the description of the method illustrated in FIG. 3 according to an embodiment of the present invention has been made of the candidate pre-join under the assumption of the channel switching at the second user terminal 100b, the present invention is not limited thereto. The pre-join method can be applied to any case where at least one user terminal requests channel switching from a current channel to a new channel.

A pre join method of the HG 300 in accordance with a channel switching request from a terminal is described as follows with reference to FIG. 4.

FIG. 4 is a flowchart illustrating a pre-join procedure of an HG in a channel switching method according to an embodiment of the present invention.

Referring to FIG. 4, the HG 300 connects a user terminal to the router 400 through a main channel selected by the user terminal and forwards the broadcast data of the main channel to the user terminal, in step 310.

Once the main channel is connected, the HG 300 pre-joins at least one candidate channel stored in its candidate channel table, in step 315. The candidate channel table is shared by the HG 300 and the content provision server 500, which store the information about the favorite channels that are frequently selected by the User terminals of the home network 100 and the adjacent channels neighboring the main channels of the user terminals. The candidate channel table can be updated using the channel preference weights and channel holding time levels calculated by the content provision server 400.

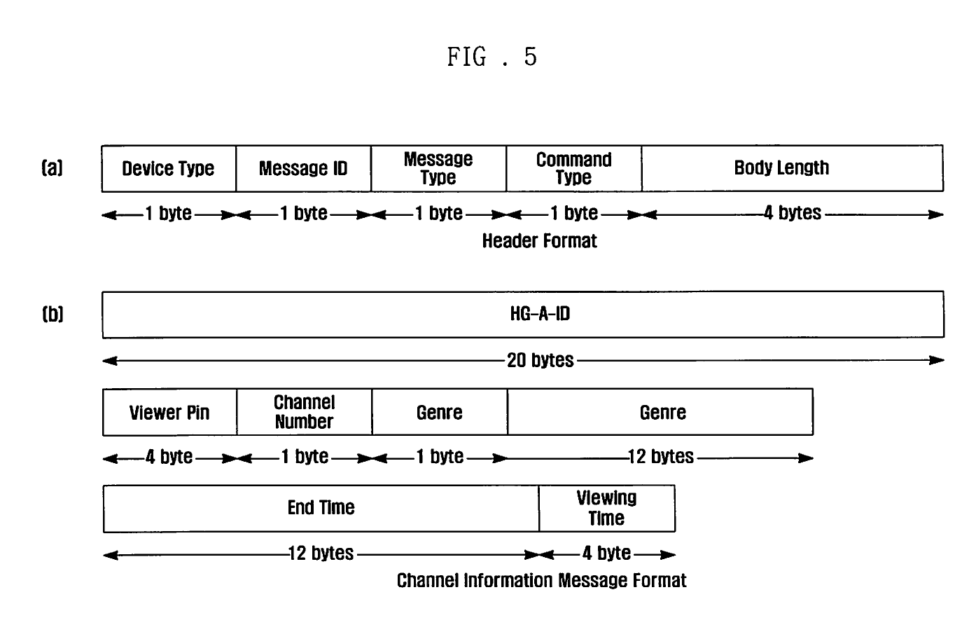

The HG 300 determines whether a main channel switching request is received from a user terminal, in step 320. If a main channel switching request is received, the HG 300 updates the channel information about the new main channel, in step 325. Next, the HG 300 sends a channel information message containing the updated channel information to the content provision server 500. The channel information message can be formatted as shown in FIG. 5.

FIG. 5 is a diagram illustrating formats of a channel information message transmitted by an HG for use in a channel switching method according to an embodiment of the present invention.

Referring to FIG. 5(a), the header of the messages exchanged between the HG 300 and the content provision server 500 includes a 1-byte device type field, a 1-byte message IDentification (ID) field, a 1-byte command type field, and 4-byte body length field.

The device type field includes a code for identifying the user terminal. The message ID field includes an identifier for mapping the channel information message or the response message. The message type field is reserved for unspecified future use. The command type field includes information for discriminating between a channel information message and a response message. The body length field indicates the length of the message body.

The channel information message includes the information fields as shown in (b) of FIG. 5 in addition to the information field of (a) of FIG. 5. Referring to (b) of FIG. 5, the channel information message includes 20-byte HG-A-ID, a 4-byte viewer Personal Identification Number (Pin) field, a 1-byte channel number field, a 1-byte genre field, a 12-byte start time field, a 12-byte end time field, and a 4-byte viewing time field.

The HG-A-ID is an identifier for the HG 300 and may be in the form of a text string. The viewer Pin is an identifier for identifying the user terminal, the channel number is a number assigned to a channel, the genre indicates the genre of the broadcast data delivered on the corresponding channel, the start time indicates the time point where the user terminal has started playback of the broadcast data, the end time indicates the time point where the user terminal has ended the playback of the broadcast data, and the viewing time indicates the total time that the user terminal has played the broadcast data.

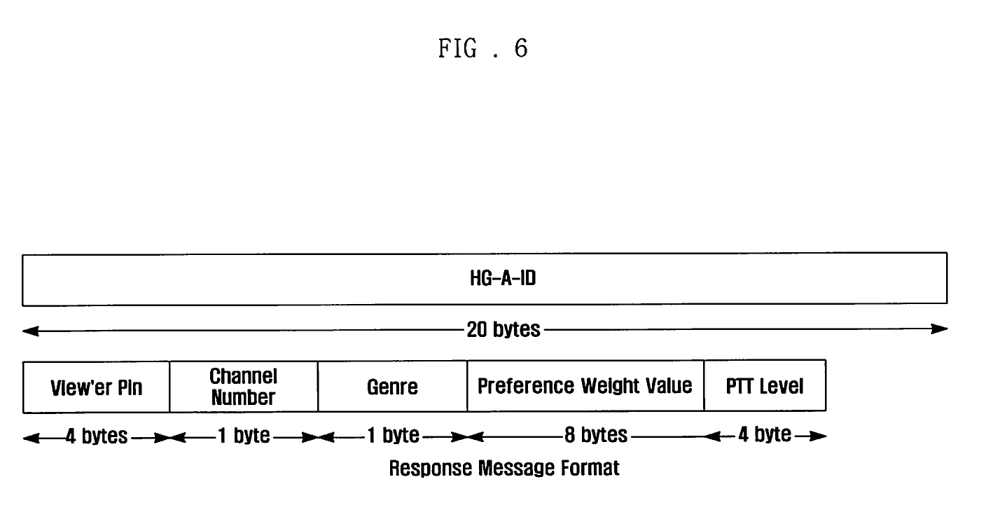

Referring to FIG. 4, after updating the channel information, the HG 300 updates the candidate channel table according to the response message transmitted by the content provision server 500, in step 330. The response message includes the per-channel preference weight and per-channel holding time level calculated by the content provision server 500. The response message can be formatted as shown in FIG. 6.

FIG. 6 is a diagram illustrating a format of a response message transmitted by a content provision server for use in a channel switching method according to an embodiment of the present invention.

Referring to FIG. 6, the response message transmitted by the content provision server 500 includes a 20-byte HG-A-ID field, a 4-byte viewer Pin field, a 1-byte channel number field, a 1-byte genre field, a 8-byte preference weight value field, and a 4-byte channel holding time level (PTT level) field.

The HG-A-ID is an identifier for the HG 300 and may be in the form of a text string, the viewer Pin is an identifier for identifying the user terminal, the channel number is a number assigned to the channel, the genre indicates the genre of the broadcast data delivered on the corresponding channel, the preference weight value is the preference weight value per channel, and PPT level is the channel holding time level set per channel. Although not depicted in FIG. 6, the response message can include the header formatted as shown FIG. 5(a). The per-channel preference weight value and channel holding time level are described in detail with reference to FIG. 7.

Returning to FIG. 4, after updating the candidate channel table, the HG 300 determines whether the main channel holding time (i.e., the play time of the broadcast data on the main channel) is greater than the channel holding time level (PTT level), in step 335. The channel holding time can be counted by the HG 300.

More specifically, if the user terminal starts playing the broadcast data on the main channel, the HG 300 checks the channel number of the main channel, the genre of the broadcast data on the main channel, and the playback start time of the broadcast data on the main channel. The HG 300 looks up the channel holding time level table of the candidate channel table for checking the channel holding time level corresponding to the main channel. The HG 300 also checks the PTT level set for the main channel from the channel holding time level table. Next, the HG 300 calculates the play time of the broadcast data played at the user terminal. The play time is compared with the PTT level. Calculation of the play time is described as follows with reference to FIG. 7.

FIG. 7 is a diagram illustrating a principle for calculating the play time on a channel in a channel switching method according to an embodiment of the present invention.

In FIG. 7, the play time of broadcast data having a size M is compared with a PTT level at time T_{playtime}. In this case, the play time of the broadcast data can be expressed Tₜ(M). If the play time of the broadcast data becomes equal to the PPT level, the broadcast data must be delivered until the time T_{transfer}=T_{residual}=Tₜ(M).

In FIG. 7, Tₜ(M) is the total play time of the broadcast data, T_{transfer} is the broadcast data transfer time equal to the PTT level, and T_{residual} is the residual play time of the broadcast data. Using the Tₜ(M), T_{transfer}, and T_{residual}, it is possible to calculate the channel holding time of the user terminal on the main channel.

The channel holding time can be calculated using Equation (1) or Equation (2).

PT=|CH−Tₛₜ−Nₜᵢₘₑ| (1)

In Equations (1) and (2), PT (Play Time) denotes the channel holding time, CH−Tₛₜ denotes the start time when the user terminal starts playing the broadcast data on the main channel, and Nₜᵢₘₑ denotes the current time.

PT=CH−Tₛₜ+PTTᵢ−L (2)

In Equation (2), PTTᵢ−L denotes a preset PTT level to the main channel.

If the channel holding time calculated by Equation (1) or Equation (2) is greater than the corresponding channel holding time level, the HG 300 releases the connection of the candidate channels, in step 340. However, only the adjacent channels among the connected candidate channels can be released in step 340. Although not depicted in FIG. 4, the HG 300 can additionally join, to the favorite channels, up to as many channels as the number of the released adjacent channels.

In step 345, the HG 300 predicts whether the broadcast data is to be played completely. The HG 300 can check the program guide provided by the content provision server 500 to predict the time when the playback of the broadcast data on the channel is completed. If it is predicted that the broadcast data is to be played completely, the HG 300 re-joins the previously released adjacent channels at β before the playback completion time of the broadcast data, in step 350.

A detailed description of pre-joining of the candidate channels in switching the main channel is explained hereinabove. A candidate channel update procedure at the content provision server on the basis of the channel information message transmitted by the HG is described hereinafter.

FIG. 8 is a flowchart illustrating a candidate channel table update procedure of the channel switching method according to an embodiment of the present invention.

Referring to FIG. 8, if the channel information message is received, the content provision server 500 stores the changed channel information of the user terminal in a database (not shown), in step 610. The channel information message can be formatted as shown in FIG. 5(b) and includes the detailed information about the channel on which the broadcast data is transferred.

In step 620, the content provision server 500 calculates the channel preference of a specific channel using the channel information stored in the database. The channel preference can be calculated based on the channel viewing time, channel selection times, genre of the broadcast data on the channel, and weight of the channel according to Equation (3):

CPᵥ(c)=f((cpₜ(c), cp_{cc}(c)cp_{g}(c), cp_{ci}(c)) (3)

where c denotes a specific channel, CPᵥ(C) denotes the channel preference of the specific channel, f denotes a function of the parameters, cpₜ(c) denotes the time connected to the specific channel, cp_{cc}(c) denotes the number of times connected to the specific channel, cpₛ(c) denotes the weight of the genre of the specific channel, and cp_{ci}(c) denotes the weight of the specific channel. In Equation (3), cp_{g}(c) can be calculated according to Equation (4). The value of cp_{g}(c) is determined as a log value for minimizing the change of the preference value even when other values increase abruptly.

$${CP}_{g} ( c ) = {log}_{10} ( {\sum }_{\text{?}} {CP}_{{g}_{i}} ) \\ \text{?} \text{indicates text missing or illegible when filed} \qquad ( 4 )$$

In Equation (4), G_{EG}(c) denotes the genre of the broadcast data that the user terminal is currently playing, G_{UH}(c) denotes the channel genre stored in the database of the content provision server 500, and gᵢ denotes the genre identical with the channel genre G_{UH}.

G_{UH}(c) is a value of the genre ‘g’ per user terminal managed in the database of the content provision server 500. The channel preference is calculated based on a sum of the weights of the viewing time, a number of channel selection times, genre, and channel importance according to Equation (5):

CP(c)=[cpₜ(c)wᵢ+cp_{cc}(c)wᵢ+cp_{g}(c)wᵢ+cp_{ci}(c)wᵢ] (5)

where wᵢ denotes the weight of each parameter, i.e. wᵢ represents the weights on the ranges of the cpₜ(c), cp_{cc}(c), cp_{g}(c), and cp_{ci}(c). In Equation (5), cpₜ(c)wᵢ is a value in the range of 0≦cpₜ(C)≦α, cp_{cc}(C)wᵢ is a value in the range of 0≦cp_{cc}(C)≦α, cp_{g}(C)wᵢ is a value in the range of 0≦cp_{g}(C)≦α, and cp_{ci}(C)wᵢ is a value in the range of 0≦cp_{ci}(C)≦α.

By calculating the channel preference using Equations (3) to (5), the content provision server 500 can obtain the channel concentration rate, in step 630. A process of calculating the channel concentration is described as follows.

The channel concentration rate is used for compensating the channel preference rate and associated with the viewing time distribution of each channel. The channel concentration rate is a relative concentration rate of each channel at the user terminal. The channel preference rate is measured based on the relative channel preference of each channel in long time, whereas the channel concentration rate is calculated based on the daily relative channel concentration rate of the user terminal.

The channel concentration can be calculated by using the Hirschman-Herfindahl Index (HHI) method represented by Equation (6). HHI is used for measurements based on the per-channel occupancy ratio of the user terminal. In an embodiment of the present invention, the channel occupancy is calculated based on the viewing time of the broadcast data at the user terminal.

$$CCR = {\sum }_{k = 1}^{n} {( \frac{View Time of channel i}{View Time of Total IPTV} )}^{2} \qquad ( 6 )$$

In Equation, (6) CCR denotes the Channel Concentration Rate of a particular day, n denotes a number of channels that have been selected at the user terminal, k denotes a viewed channel, View Time of channel i denotes the time during which the broadcast data of channel i has been played, and View Time of Total IPTV denotes the total time for which the broadcast data on the selected channels are played at the user terminal. As shown in Equation (4), CCR is the sum of squares of the values obtained by subtracting the play time of each channel by the total play time.

In this manner, it is possible to standardize the number of different channels and the play time of the broadcast data on the channels per user terminal. The channel concentration rate has a value in the range from “1/(the total number of channels)” to 1. If the channel concentration rate is “1/(the total number of channels)”, the user terminal has played the broadcast data on the channels for identical length of time. If the channel concentration rate is 1, the user terminal has played the broadcast data on a single channel. The channel concentration rate per user terminal can be measured daily.

After calculating the channel preference rate, the content provision server 500 calculates the channel preference weight per user, in step 640. The per-user channel preference weight is calculated by substituting the channel preference rate and the channel concentration rate into Equation (7):

$${PCPW}_{i} = ( {CP ( C )}_{i} + {CCR}_{i} ) \times log [ \frac{\begin{matrix}( {UH}_{i} + 0.5 ) \\ ( CT - {ct}_{i} + 0.5 )\end{matrix}}{\begin{matrix}( {ct}_{ii} + 0.5 ) \\ ( UH - {uh}_{i} + 0.5 )\end{matrix}} ] + α \qquad ( 7 )$$

where PCPW denotes a Personalized Channel Preference Weight, CP(C)ᵢ denotes the channel preference rate of channel i, CCRᵢ denotes the channel concentration rate of channel i, UH denotes a number of channels stored in the database of the content provision server 500, uhᵢ denotes a number of channels on which the current event occurs among the UH channels, CT denotes the total number of channels provided by the content provision server 500, and ctᵢ denotes a number of channels related to the main channel. The rank of a channel is assigned according to the PCPW per channel.

After calculating the channel preference weights, the content provision server 500 calculates the channel holding level (Play Time Threshold Level or PTT Level) per channel using the received channel information, in step 650. By assigning the threshold value according to the time for which the broadcast data of a channel is played by the user terminal, an optimized threshold value can be set for the channel.

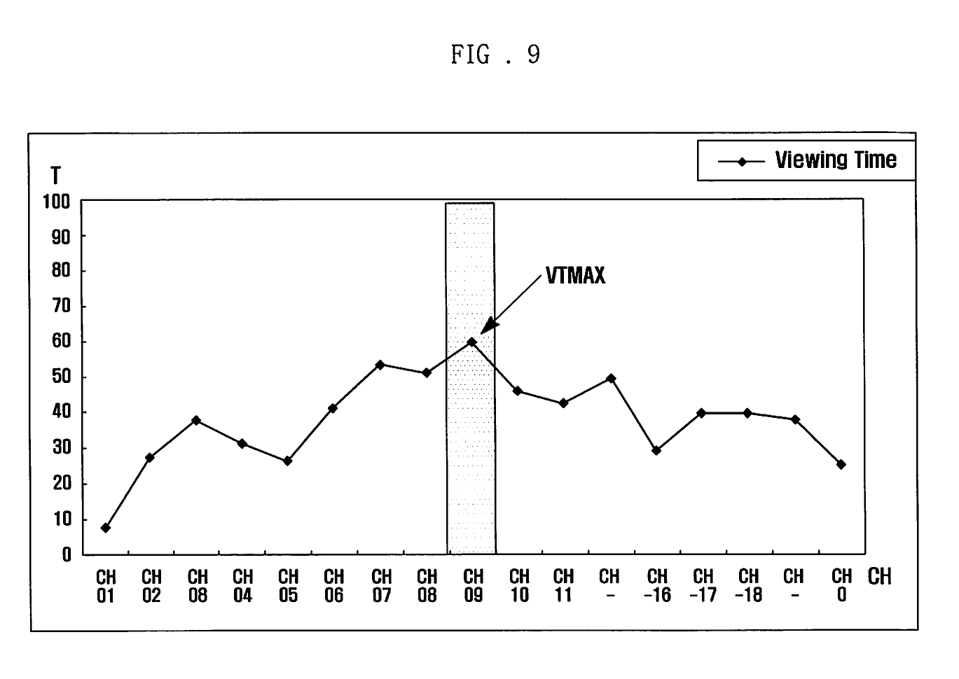

The PTT Level is calculated based on the viewing time of the broadcast data on the corresponding channel. The channels have different viewing times, and the maximum value (Viewing Time Maximum or VT_{MAX}) is selected among the viewing times. A process for extracting the VT_{MAX} is described as follows with reference to FIG. 9.

FIG. 9 is a graph illustrating a principle of extracting the VTMAX for the channel switching method according to an embodiment of the present invention.

Referring to FIG. 9, the horizontal axis of the graph represents channel indices, and the vertical axis of the graph represents the amount of time for which the broadcast data of the corresponding channel has been played. In FIG. 9, the channel of which broadcast data is played for the longest time is CH9. Accordingly, the play time (or viewing time) value ‘55’ on the channel CH9 is selected as VT_{MAX}.

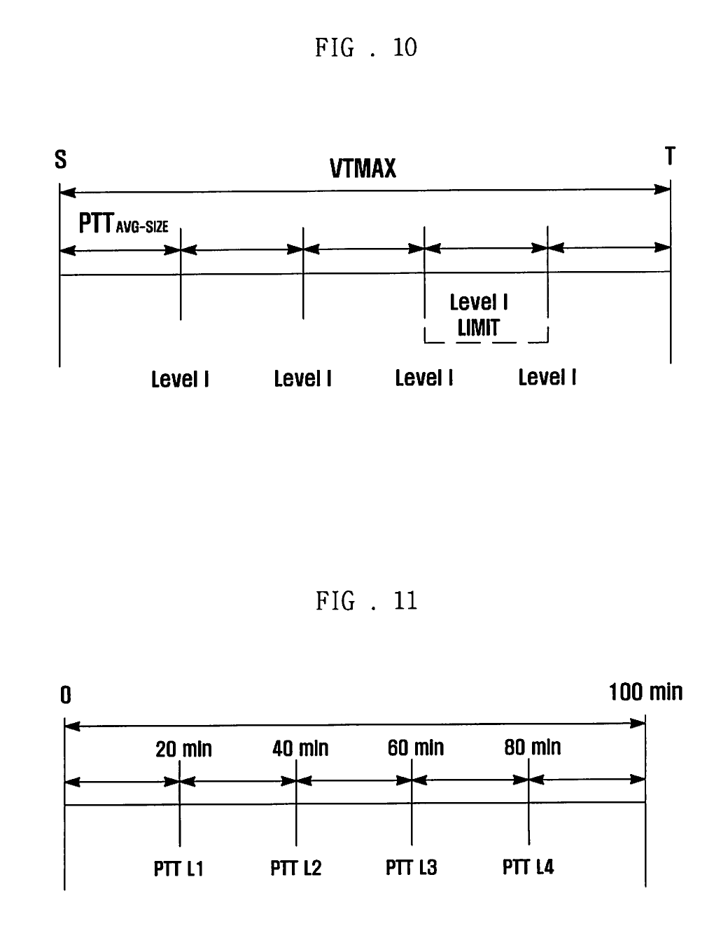

The selected VT_{MAX} is equally divided by a value α using Equation (8). In Equation (8), α is an optional value and can be changed by the service provider managing the content provision server or according to statistic values of the broadcast data play times of the channels.

$${PTT}_{Avg \text{-} size} = \frac{{VT}_{MAX}}{α} \qquad ( 8 )$$

where PTT_{Avg-size} denotes of an average range of VT_{MAX} divided by α and this range becomes the PTT level. Determination of the PTT level is described as follows with reference to FIG. 10.

FIG. 10 is a diagram illustrating a principle of determining the PTT level in the channel switching method according to an embodiment of the present invention.

In FIG. 10, ‘S’ denotes a minimum broadcast data play time (e.g. viewing time is 0), ‘T’ denotes a maximum broadcast data play time, PTT_{Avg-size} denotes the average size of segments as a result of the division of the VT_{MAX} by α, VT_{MAX} denotes the maximum value of the viewing time, and Level I denotes the PPT level from the reference of the PTT_{Avg-size}. The limit value of Level I refers to the range of a Level, i.e. the size of Level I. For instance, if 4 PTT levels are classified and the VT_{MAX} is 100 m, the PTT level can be determined as shown in FIG. 11.

FIG. 11 is a diagram illustrating PPT levels for use in the channel switching method according to an embodiment of the present invention.

Referring to FIG. 11, the PPT levels are classified into four levels: PTT L1, PTT L2, PTT L3, and PTT L4. The threshold values are 20 min for PTT L1, 40 min for PTT L2, 60 min for PTT L3, and 80 min for PTT L4. Using the PTT levels configured by the content provision server 500, the HG 300 can release the pre-joined candidate channels. Assuming that the user terminal plays the broadcast data received on the channel CH9 and the PTT Level of CH9 is PTT L2 of 20 min, the HG 300 releases the pre-joined candidate channels when the broadcast data play time PT is greater than PTT L2, i.e. 40 minutes.

In order to assign the PTT levels to the respective channel, the average broadcast data play time (VT_{AVG}) per channel is calculated. Assuming that the broadcast data play times of CHᵢ are CH_{day1T}, CH_{day2T}, CH_{day3T}, . . . , CH_{daynT}, the average broadcast data play time (VT_{AVG}) can be calculated by Equation (9):

$${VT}_{Avg} = \frac{l}{n} {\sum }_{i = l}^{n} {CH}_{dayiT} \qquad ( 9 )$$

where n denotes the total number of channels transferring the broadcast data, and CH_{dayiT} denotes the broadcast data play time on the channel CHi.

The VT_{Avg} calculated with Equation (9) is divided by α, which is used for classifying the PPT Levels. By dividing the VT_{Avg} of the corresponding channel by α, it is possible to uniformly assign the Levels. In order to improve the level assignment precision, the CCR is applied to the divided value as Equation (10):

$${VT}_{Avg\_dis} = ( \frac{{VT}_{Avg}}{α} ) \times ( \vert CCR - 1 \vert ) \qquad ( 10 )$$

where VT_{Avg-dis} denotes the level assignment value compensated by applying the weight of the channel to the value obtained for level assignment.

If the value of the VT_{Avg-dis} for the channel is in the range of PTT_{Avg-size}, the PTT level can be assigned. Assuming that the PTT_{Avg-sizes} are 0˜20 (PTT L1=20), 21˜40 (PTT L2=40), 41˜60 (PTT L3=60), and 61˜80 (PTT L4—80), and the calculated VT_{AVG-dis} is 18, the channel is assigned the level PTT L1.

Returning to FIG. 8, after assigning the channel holding time levels to the respective channels, the content provision server 500 updates the candidate channel table using the channel holding time levels and channel preference weights, in step 660. The candidate channels stored in the candidate channel table are assigned the channel preference ranks per user terminal with the Personalized Channel Preference Weights (PCPWs) calculated by the content provision server 500. The content provision server 500 sends the updated candidate channel table to the HG 300. As a consequence, the HG 300 pre-joins n high-ranking channels in the updated candidate channel table.

As described above, a channel switching method according to embodiments of the present invention includes acquiring the information of the user favorite channels effectively and pre-joins the candidate channels using the acquired user favorite channel information, thereby minimizing the channel zapping time. Also, the channel switching method according to embodiments of the present invention allows fast channel switching and reduces bandwidth waste, resulting in an improvement of bandwidth utilization. The channel switching method according to embodiments of the present invention also includes releasing unnecessarily joined candidate channels by checking the channel holding time to the current channel, thereby reducing the waste of bandwidth and improving bandwidth utilization efficiency.

Although embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A channel switching method for a system playing broadcast data delivered on a plurality of channels, comprising:
pre-joining candidate channels while playing broadcast data on a main channel, the pre-joined candidate channels being stored in a candidate channel table;
releasing, when a channel holding time of the main channel is greater than a predetermined channel holding time level, the pre joined candidate channels; and
re-joining the released candidate channels before a completion of playing the broadcast data on the main channel.

2. The channel switching method of claim 1, wherein pre-joining the candidate channels comprises:
transmitting, when a channel switching event is detected, a channel information message to a content provision server;
calculating, by the content provision server, a channel preference weight per each channel and a channel holding time per channel;
transmitting the channel preference weight for each of the plurality of channels and the channel holding time for each of the plurality of channels to the home gateway;
updating, by a home gateway, the candidate channel table with the channel preference weights and the channel holding time levels; and
joining the updated candidate channels in the candidate channel table.

3. The channel switching method of claim 1, wherein the candidate channels include at least one adjacent channel neighboring the main channel and at least one favorite channel selected based on numbers of connections to each of the plurality of channels to a user terminal.

4. A channel switching method of a home gateway delivering broadcast data from a content provision server to a user terminal, comprising:
transmitting, to the user terminal, broadcast data of a main channel selected by the user terminal;
pre-joining candidate channels selected in association with the main channel;
determining whether a main channel holding time of the user terminal is greater than a predetermined channel holding time level;
releasing the pre joined candidate channels when the main channel holding time of the user terminal is greater than the channel holding time level; and
re-joining the released candidate channels before a completion of playing the broadcast data on the main channel.

5. The channel switching method of claim 4, wherein pre-joining candidate channels comprises:
updating, when a channel switching event from the user terminal is detected, a candidate channel table storing the candidate channels; and
pre-joining the updated candidate channels in the candidate channel table.

6. A channel switching system comprising:
a home gateway for transmitting broadcast data on a main channel, pre-joining candidate channels stored in a candidate channel table in association with the main channel, releasing the pre-joined candidate channels when a channel holding time of the main channel is greater than a predetermined channel holding time level, checking a play completion time of the broadcast data on the main channel, and re-joining the released candidate channels before the play completion time; and
at least one user terminal for playing the broadcast data transmitted by the home gateway and transmitting, when a main channel switching event is detected, a channel switching request to the home gateway.

7. The channel switching system of claim 6, further comprising a content provision server for receiving a channel information message transmitted by the home gateway in response to the main channel switching event at the at least one user terminal, calculating a channel preference weight for each of a plurality of channels based on the channel information message, and transmitting the calculated channel preference weights to the home gateway.

8. The channel switching system of claim 7, wherein the home gateway updates the candidate channel table with the channel preference weights and joins the candidate channels updated in the candidate channel table.

9. The channel switching system of claim 6, wherein the candidate channels include at least one adjacent channel neighboring the main channel and at least one favorite channel selected based on numbers of connections to each of the plurality channels to each of the at least one user terminal.
